(19) United States
(12) Patent Application Publication
(10) Pub. No.: US 2026/0362043 A1
(43) Pub. Date: Nov. 12, 2026

(54) POSITION ESTIMATION APPARATUS, POSITION ESTIMATION METHOD, AND PROGRAM

(71) Applicant: NTT, Inc., Tokyo (JP)

(72) Inventors: Tatsuya KAKO, Musashino-shi, Tokyo (JP); Shihori KOZUKA, Musashino-shi, Tokyo (JP); Hironobu CHIBA, Musashino-shi, Tokyo (JP); Hiroaki ITO, Musashino-shi, Tokyo (JP); Kenichi NOGUCHI, Musashino-shi, Tokyo (JP)

(73) Assignee: NTT, Inc., Tokyo (JP)

(21) Appl. No.: 19/119,435

(22) PCT Filed: Oct. 26, 2022
(86) PCT No.: PCT/JP2022/039936

§ 371 Date: Apr. 9, 2025

(51) Int. Cl. H04R 1/10; H04R 29/00

(52) U.S. Cl. CPC H04R 1/1041; H04R 1/1008; H04R 29/001

(57) ABSTRACT

A position estimation apparatus that estimates whether or not a wearing position of an open-ear type earphone to an ear is correct. The position estimation apparatus includes a memory that stores a resonance frequency fᵢ of space formed by a user's ear and an open-ear type earphone, and an estimation unit that obtains a resonance frequency f₂ of the space formed by the user's ear and the open-ear type earphone by using a sound collection signal obtained by collecting sound by a microphone included in the open-ear type earphone when a predetermined signal is reproduced when the user is wearing the open-ear type earphone. The apparatus estimates that the open-ear type earphone is worn at an ideal position of the user's ear when resonance frequencies coincide with each other.

### TECHNICAL FIELD

The present invention relates to a technique for reproducing an acoustic signal with an open-ear type earphone which does not block an external auditory canal.

### BACKGROUND ART

Earphones include a canal type earphone for blocking the external auditory canal and an open-ear type earphone for not blocking the external auditory canal. In the canal type earphone, an “ear tip” having a shape similar to that of an ear plug is attached to the tip of the earphone, and the external auditory canal is sealed. In the canal type earphone, it is necessary to select the ear tip matching a size of an ear hole, but it is difficult for a user to determine whether the ear tip is an optimum size. Therefore, as a conventional technique for judging whether or not the canal type earphone of the optimum size is worn, NPL 1 is known. NPL 1 describes that it is possible to confirm whether or not the canal type earphone is worn with the external auditory canal sealed by reproducing sound in a state where the canal type earphone is worn thereon.

### CITATION LIST

### Non Patent Literature

[NPL 1] “Choose your AirPods Pro ear tips and use the Ear Tip Fit Test”, [online], 2020, Apple Inc., [retrieved on Oct. 17, 2022], the Internet <URL: https://support.apple.com/ja-jp/HT210633>

### SUMMARY OF INVENTION

### Technical Problem

In the case of the open-ear type earphone, part of the earphone is hooked and worn on a part called a concha of an auricle (a part protruding outside of the entire ear). Since the open-ear type earphone does not use the ear tip, it is not required to adjust the size.

However, there is a case where the user cannot grasp whether or not the wearing position of the open-ear type earphone to the ear is correct. When the open-ear type earphone cannot be worn at a correct position, there is a problem that acoustic characteristics are changed and sound characteristics are changed, and direction perception of stereophonic sound is not correct.

An object of the present invention is to provide a position estimation apparatus, a position estimation method, and a program that estimate whether or not a wearing position of an open-ear type earphone to an ear is correct.

### Solution to Problem

In order to solve the above-described problem, according to one aspect of the present invention, a position estimation apparatus includes a storage unit that stores a resonance frequency f₁ of space formed by a user's ear and an open-ear type earphone, and an estimation unit that obtains a resonance frequency f₂ of the space formed by the user's ear and the open-ear type earphone by using a sound collection signal obtained by collecting sound by a microphone included in the open-ear type earphone when a predetermined signal is reproduced by a speaker included in the open-ear type earphone in a state where the user is wearing the open-ear type earphone and estimates that the open-ear type earphone is worn at an ideal position of the user's ear when the resonance frequencies f₁ and f₂ coincide with each other, wherein the resonance frequency fᵢ is obtained by using the sound collection signal obtained by collecting sound by the microphone when the predetermined signal is reproduced by the speaker in the state where the open-ear type earphone is worn at the ideal position of the user's ear.

### Advantageous Effects of Invention

According to the present invention, effect is that it is possible to estimate whether or not the wearing position of the open-ear type earphone including a speaker and a microphone to the ear is correct without using a special device.

### BRIEF DESCRIPTION OF DRAWINGS

FIG. 1 is a diagram for explaining a situation of simulation.

FIG. 2 is a diagram showing relation between volume of space and a resonance frequency.

FIG. 3 is a diagram showing frequency characteristics measured while changing a wearing position of an open-ear type earphone.

FIG. 4 is a diagram showing an example of the wearing position.

FIG. 5 is a functional block diagram of a position estimation apparatus according to a first embodiment.

FIG. 6 is a diagram showing an example of a processing flow of the position estimation apparatus according to the first embodiment.

FIG. 7 is a diagram showing a configuration example of a computer to which the present means is applied.

### DESCRIPTION OF EMBODIMENTS

Hereinafter, embodiments of the present invention will be described. Note that, in the drawings used for the following description, the same reference numerals are given to configuration units having the same functions or steps of performing the same processing, and repeated description thereof will be omitted.

### Points of First Embodiment

In the present embodiment, it is estimated whether a wearing position is correct by using a resonance frequency generated between an open-ear type earphone and an ear.

An open-ear type earphone often has a microphone for voice acquisition in a housing in order to realize not only music appreciation but also voice communication, voice recognition, and the like by being connected to a smart phone or a PC. In addition, not only the microphone for voice acquisition, but also a microphone for environmental sound acquisition is often provided in the housing in order to realize noise cancellation, echo cancellation, and the like. The open-ear type earphone according to the present embodiment also includes a speaker and a microphone.

In the present embodiment, it is estimated whether the wearing position of the open-ear type earphone to the ear is correct by using a phenomenon that the resonance frequency changes in accordance with volume of space formed by the ear and the housing of the open-ear type earphone.

For example, a predetermined signal is reproduced from the speaker included in the open-ear type earphone, and the reproduced sound is collected by the microphone included in the open-ear type earphone. The resonance frequency generated in the space between the ear and the housing is obtained from the frequency characteristics of a collected acoustic signal, and it is estimated from the obtained resonance frequency whether the wearing position of the open-ear type earphone is a usual wearing position (appropriate wearing position) or a wearing position (inappropriate wearing position) different from the usual wearing position.

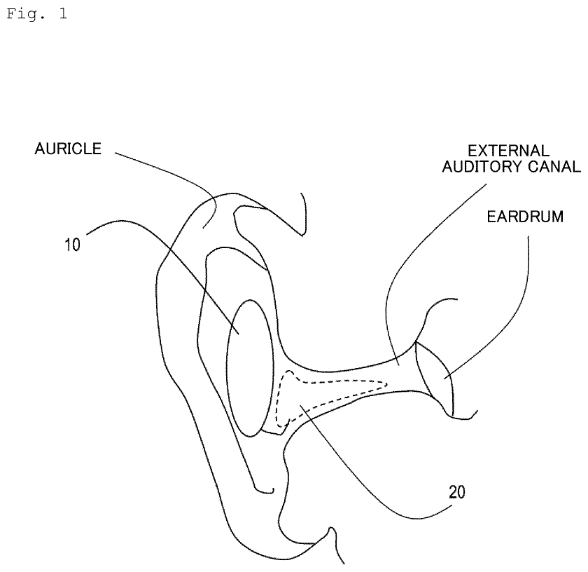

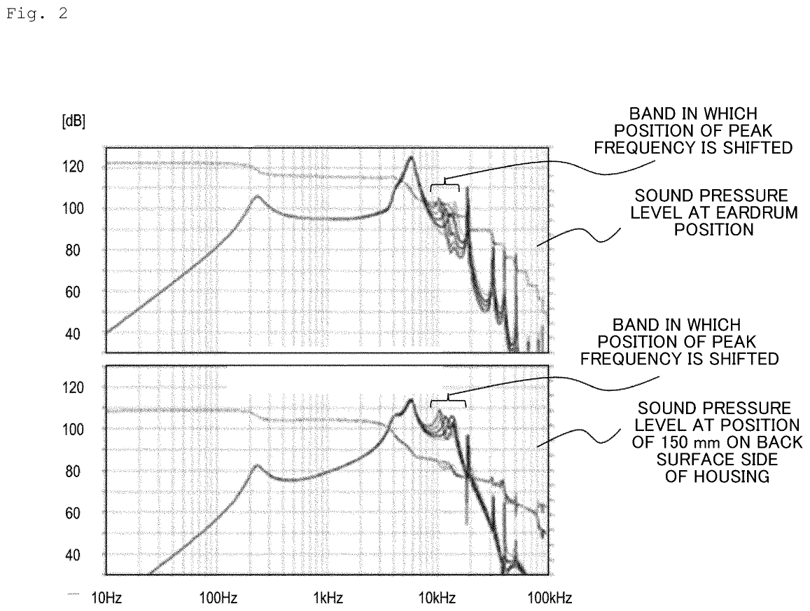

A description will be given of a change in resonance frequency in accordance with the volume of space formed by the ear and the housing of the open-ear type earphone. The relation between the volume of space and the resonance frequency is obtained by simulation. FIG. 1 is a diagram for explaining a simulation situation, and FIG. 2 is a diagram showing the relation between the volume of space and the resonance frequency. In this simulation, the volume of space 20 is changed by changing the position of the housing 10 of the open-ear type earphone. In this simulation, the volume is changed every 200 mm³, and the frequency characteristics are obtained from 600 mm³ to 1400 mm³. In the simulation, a sound pressure level at an eardrum position and the sound pressure level at a 150 mm position on a back surface side of the housing are obtained. Note that the back surface of the housing is opposite to the surface on which the earphone is worn, and the position of 150 mm on the back surface side of the housing is a position apart from the back surface side of the housing by 150 mm in a direction of the back surface of the housing when viewed from a center of the housing.

As shown in FIG. 2, a position of a peak frequency appearing in a band of 10 khz to 11 khz shifts either at the eardrum position or at the 150 mm position on the back surface side of the housing. Note that as the space becomes smaller, the position of the peak frequency shifts to high frequency range. In the present embodiment, the position of the peak frequency is observed to determine whether the open-ear type earphone is worn at a position different from the usual one.

As a method for acquiring the resonance frequency, an impulse response is obtained by a TSP method, and the resonance frequency is obtained from the impulse response. For example, a TSP (Time Stretched Pulse) signal is reproduced from the speaker included in the open-ear type earphone, and a signal reproduced by the microphone included in the open-ear type earphone is collected. By convoluting the time inversion TSP signal with the collected signal, an extended signal is compressed (converting into impulse) to obtain the impulse response.

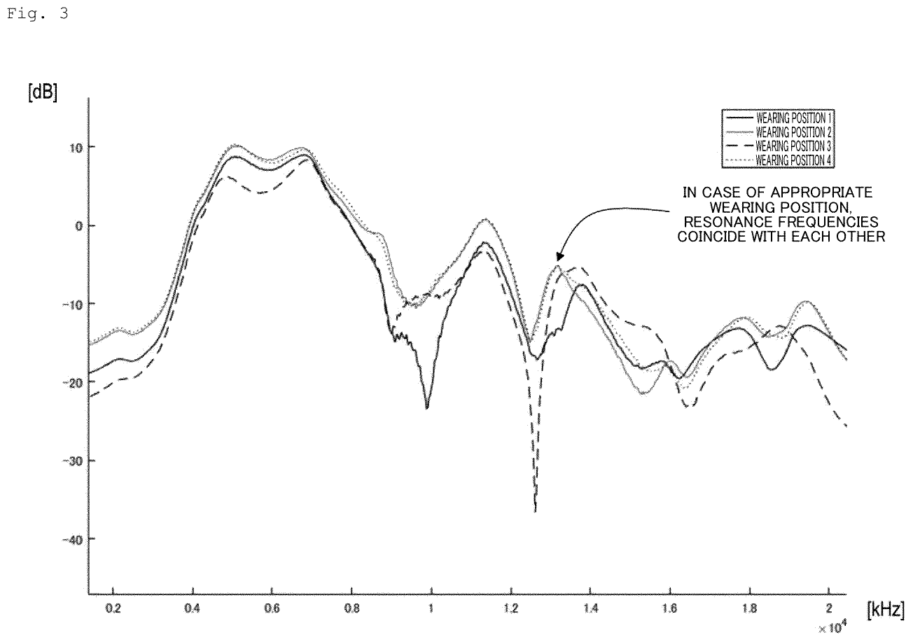

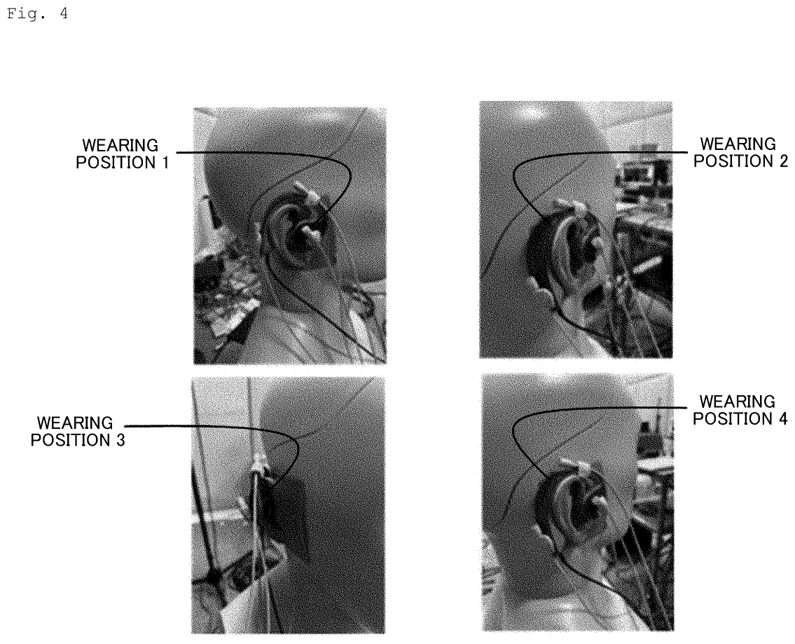

FIG. 3 shows frequency characteristics measured while changing the wearing position of the open-ear type earphone. FIG. 4 is a diagram showing an example of the wearing position. The wearing positions 1 and 3 show examples where the open-ear type earphone is worn at a position (inappropriate wearing position) different from the usual wearing position, and the wearing positions 2 and 4 show examples where the open-ear type earphone is worn at the same position (appropriate wearing position) as the usual wearing position.

As shown in FIG. 3, when the open-ear type earphone is worn at the appropriate wearing position, the same frequency has the peak, and when the open-ear type earphone is worn at the inappropriate wearing position, the peak frequency is different. Thus, by confirming the resonance frequency generated between the ear and the open-ear type earphone, it is possible to estimate whether the ear is at the appropriate wearing position or the inappropriate wearing position.

With such a configuration, it is possible to estimate whether the wearing position is correct from the speaker and the microphone included in the general open-ear type earphone without using a special sensor or the like, and to solve the problem that the wearing position of the open-ear type earphone does not settle in the appropriate wearing position. Particularly, in the case of an ear-hook type open-ear type earphone, the wearing position is prone to shift, and the present claimed invention is useful.

### First Embodiment

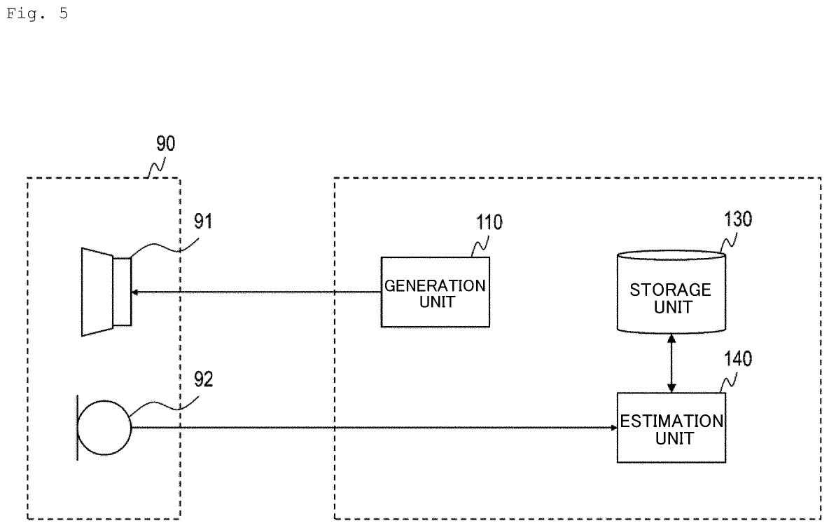

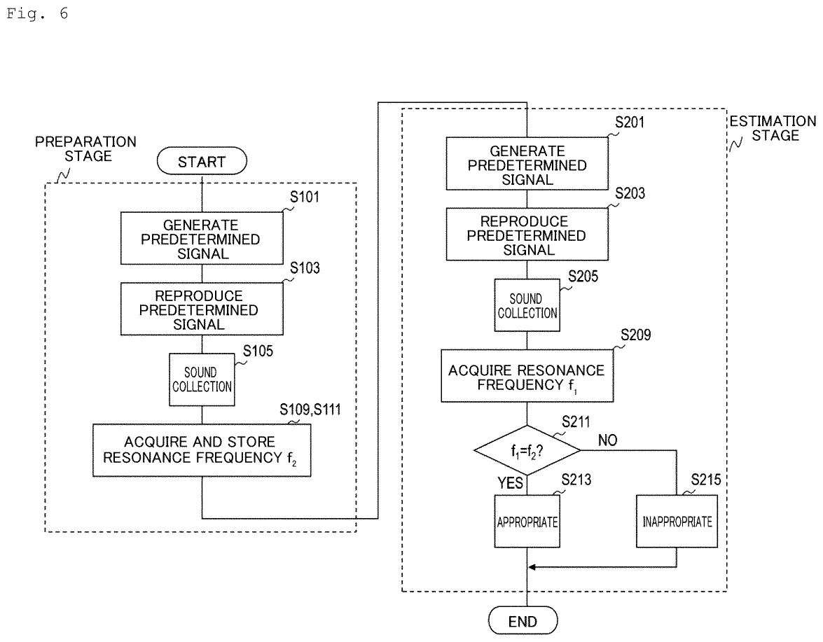

FIG. 5 shows a functional block diagram of the position estimation apparatus according to the first embodiment, and FIG. 6 shows a processing flow.

The position estimation apparatus includes a generation unit 110, a storage unit 130, and an estimation unit 140.

The position estimation apparatus is communicably connected to the open-ear type earphone 90 by wire or wireless and outputs a predetermined signal reproduced by a speaker 91 included in the open-ear type earphone 90. Further, the position estimation apparatus inputs a sound collection signal obtained by collecting a predetermined signal reproduced by the speaker 91 by a microphone 92 included in the open-ear type earphone 90.

The position estimation apparatus estimates a wearing position of the open-ear type earphone from the sound collection signal and outputs an estimation result.

The position estimation apparatus is, for example, a special device configured by reading a special program into a known or dedicated computer having a central arithmetic processing device (CPU: Central Processing Unit) and a main storage device (RAM: Random Access Memory), and the like. The position estimation apparatus performs each processing under control of the central arithmetic processing device, for example. Data inputted to the position estimation apparatus and data obtained through various types of processing are stored in the main memory device, for example, and the data stored in the main storage device is read into the central arithmetic processing device and is used in other types of processing as necessary. At least part of each processing unit of the position estimation apparatus may be configured by hardware such as an integrated circuit. Each storage unit provided in the position estimation apparatus can be configured by the main storage device such as a RAM (Random Access Memory) or middleware such as a relational database or a key-value store, for example. However, each storage unit does not need to be necessarily provided inside the position estimation apparatus and is configured by an auxiliary storage device configured by a semiconductor memory element such as a hard disk, an optical disk, or a Flash Memory, and may be configured to be provided outside the position estimation apparatus.

The estimation processing includes a preparation stage, which is performed before estimating the wearing position, and an estimation stage. First, the preparation stage will be described.

### Preparation Stage

First, a user of the open-ear type earphone wears the open-ear type earphone at an ideal position (appropriate wearing position) on an auricle. Note that determination of whether the open-ear type earphone is worn at the ideal position may be subjectively determined by the user or may be objectively determined by a third party having expert knowledge by confirming the wearing position.

The generation unit 110 generates a predetermined signal to be reproduced by the speaker 91 (S101) and outputs it to the speaker 91. For example, the predetermined signal is a TSP signal.

The predetermined signal is reproduced by the speaker 91 in a state where the open-ear type earphone is worn at the ideal position on the user's ear (S103).

The sound reproduced by the speaker 91 is collected by the microphone 92 (S105).

The estimation unit 140 inputs the sound collection signal obtained by collecting sound by the microphone 92, obtains a resonance frequency f₂ of the space formed by the user's ear and the open-ear type earphone by using the sound collection signal (S109), and stores it in the storage unit 130 (S111). For example, when the predetermined signal is a TSP signal, the estimation unit 140 obtains an impulse response by compressing (converting into impulse) a signal extended by convoluting a time inversion TSP signal with the sound collection signal by a TSP method, and obtains the resonance frequency f₂ from the impulse response.

The preparation stage includes the above pieces of processing S101 to S111. Next, the estimation stage will be described.

### Estimation Stage

First, the user of the open-ear type earphone wears the open-ear type earphone on the auricle.

The generation unit 110 generates a predetermined signal to be reproduced by the speaker 91 (S201) and outputs it to the speaker 91. For example, a signal similar to the signal used in the preparation stage is used as the predetermined signal.

The predetermined signal is reproduced by the speaker 91 in a state where the open-ear type earphone is worn on the user's ear (S203).

The sound reproduced by the speaker 91 is collected by the microphone 92 (S205).

The estimation unit 240 inputs the sound collection signal obtained by collecting sound by the microphone 92, and obtains the resonance frequency fᵢ of the space formed by the user's ear and the open-ear type earphone by using the sound collection signal (S209). Note that the same method as the preparation stage is used for obtaining the resonance frequency from the sound collection signal. The estimation unit 240 refers to the resonance frequency f₂ stored in the storage unit 130, estimates that the open-ear type earphone is worn at the ideal position of the user's ear when the resonance frequencies f₁ and f₂ coincide with each other (YES in S211), and outputs the estimation result indicating that the wearing position is appropriate (S213). When the resonance frequencies f₁ and f₂ do not coincide with each other (NO in S211), the estimation unit 240 estimates that the open-ear type earphone is not worn at the ideal position of the user's ear, and outputs the estimation result indicating that the wearing position is inappropriate (S215). Note that coincidence of the resonance frequencies f₁ and f₂ includes not only the case where they are completely coincided but also the case where the difference between the resonance frequencies f₁ and f₂ is within a predetermined range. In actual use, the position of the open-ear type earphone changes delicately even when it is worn at the appropriate position, and the resonance frequency changes delicately in accordance with the change. Therefore, when a difference between the resonance frequencies f₁ and f₂ is within a range which can be regarded as being worn at the ideal position, it is regarded that the resonance frequencies f₁ and f₂ coincide with each other.

### EXAMPLE

In the present example, the position estimation apparatus is mounted on a smart phone.

First, the preparation stage will be described.

When the smart phone mounting the position estimation apparatus and the open-ear type earphone 90 are communicably connected by wire or wireless, an application for position estimation is started automatically or by user's operation, and the processing of the preparation stage is executed.

When the application is started, the position estimation apparatus displays a message instructing the user to wear the open-ear type earphone 90 at the appropriate position and reproduce a predetermined signal on a touch panel of the smart phone. For example, the position estimation apparatus displays a reproduction button together with a message “Please wear an open-ear type earphone 90 at an appropriate position and tap a ”reproduction“ button.”.

When an operation intended to reproduce a predetermined signal is performed (for example, when a “reproduction” button is tapped), the position estimation apparatus generates the predetermined signal (S101) and reproduces it by the speaker 91 (S103). Further, the sound reproduced by the speaker 91 is collected by the microphone 92 (S105), the position estimation apparatus obtains the resonance frequency f₂ by using the sound collection signal (S109), and stores it in the storage unit 130 (S111). When the obtained resonance frequency f₂ is within an appropriate range, the position estimation apparatus displays a message indicating that preparation for position estimation is completed on the touch panel of the smart phone. For example, the position estimation apparatus displays a message “An appropriate position of an open-ear type earphone 90 is registered.”. When the obtained resonance frequency f₂ is not within the appropriate range, the position estimation apparatus displays a message indicating that the position estimation is not completed on the touch panel of the smart phone. For example, the position estimation apparatus displays the reproduction button together with a message “An open-ear type earphone 90 is not worn at an appropriate position. Please re-wear it at the appropriate position and tap a “reproduction” button again.”, and repeats the pieces of processing S101 to S111. Note that the appropriate range of the resonance frequency f₂ may be acquired in advance by experiments or simulation in consideration of various shapes and sizes of ears.

Next, the estimation stage will be described.

When the smart phone mounting the position estimation apparatus and the open-ear type earphone 90 are communicably connected by wire or wireless, the application for position estimation is started automatically or by user's operation, and executes the processing of the estimation stage.

When the application is started, the position estimation apparatus automatically generates a predetermined signal (S201) and reproduces it by the speaker 91 (S203). Further, the sound reproduced by the speaker 91 is collected by the microphone 92 (S205), and the resonance frequency fᵢ is obtained by using the sound collection signal (S209). When the obtained resonance frequency fᵢ and the resonance frequency f₂ stored in the storage unit 130 coincides with each other (YES in S211), the position estimation apparatus may display a message indicating that the open-ear type earphone 90 is worn at the appropriate position on the touch panel of the smart phone, or may not display any message (in this case, no message is displayed means that the open-ear type earphone 90 is worn at the appropriate position). When the resonance frequencies f₁ and f₂ do not coincide with each other (NO in S211), the position estimation apparatus displays a message indicating that the open-ear type earphone 90 is not worn at the appropriate position on the touch panel of the smart phone and a message urging the user to re-wear the open-ear type earphone 90 at the appropriate position.

For example, the position estimation apparatus displays a completion button together with a message saying, “An open-ear type earphone 90 is not worn at an appropriate position. Please re-wear it at the appropriate position and tap a “completion” button.”. When the “completion” button is tapped, the above-described pieces of processing S201 to S211 are repeated.

### Effects

With the above configuration, it is possible to estimate whether or not the wearing position of the open-ear type earphone including the speaker and the microphone to the ear is correct without using a special device.

### Modification Example 1

In the present embodiment, the predetermined signal is generated by the generation unit 110, but the predetermined signal generated in advance may be stored in a storage unit which is not shown and be outputted to the speaker 91. In this case, the position estimation apparatus may not include the generation unit 110.

### Other Modification Examples

The present invention is not limited to the above-described embodiment and modification example. For example, the above-described various types of processing may be performed chronologically as described above, and may also be performed in parallel or individually in accordance with a processing capability of a device performing the processing or as necessary. Otherwise, changes can be made appropriately within the scope of the present invention without departing from the gist of the present invention.

### Program and Recording Medium

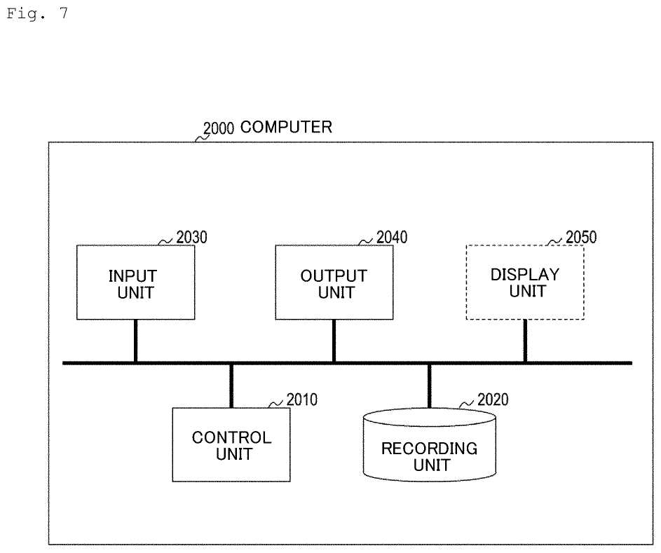

The above-described various types of processing can be performed by causing a recording unit 2020 of a computer 2000 shown in FIG. 7 to read a program for executing each step of the above-described method, and causing a control unit 2010, an input unit 2030, an output unit 2040, a display unit 2050, and the like to operate the program.

The program describing this processing content can be recorded on a computer-readable recording medium. As the computer-readable recording medium, for example, any recording medium such as a magnetic recording device, an optical disc, a magneto-optical recording medium, and a semiconductor memory may be used.

In addition, the program is distributed, for example, through sales, transfer, lending, or the like of a portable recording medium such as a DVD or a CD-ROM on which the program is recorded. Further, the program may be distributed by storing the program in advance in a storage device of a server computer and transferring the program from the server computer to another computer via a network.

The computer that executes such a program first temporarily stores, for example, the program recorded on the portable recording medium or the program transferred from the server computer in an own storage device. Then, when processing is executed, the computer reads the program stored in the own recording medium and executes processing in accordance with the read program. In addition, as another execution mode of the program, the computer may directly read the program from the portable recording medium and execute the processing in accordance with the program. Further, whenever the program is transferred from the server computer to the computer, the processing may be executed sequentially in accordance with the received program. Further, instead of transferring the program from the server computer to the computer, the above-described processing may be executed by a so-called ASP (Application Service Provider) type service in which a processing function is implemented with an execution instruction and result acquisition alone. Note that the program in the present mode includes information that is used for processing by an electronic computer and is equivalent to the program (data or the like that is not a direct command for the computer but has a property that defines processing performed by the computer).

In addition, although the present device is configured by executing a predetermined program on the computer in this mode, at least part of the processing content may be implemented by hardware.

1. A position estimation apparatus comprising:
a memory configured to store a resonance frequency f₁ of space formed by a user's ear and an open-ear type earphone; and
processing circuitry configured to obtain a resonance frequency f₂ of the space formed by the user's ear and the open-ear type earphone by using a sound collection signal obtained by collecting sound by a microphone included in the open-ear type earphone when a predetermined signal is reproduced by a speaker included in the open-ear type earphone in a state where the user is wearing the open-ear type earphone, and estimate that the open-ear type earphone is worn at an ideal position of the user's ear when the resonance frequencies f₁ and f₂ coincide with each other, wherein
the resonance frequency fᵢ is obtained by using the sound collection signal obtained by collecting sound by the microphone when the predetermined signal is reproduced by the speaker in the state where the open-ear type earphone is worn at the ideal position of the user's ear.

2. A position estimation method, implemented by a position estimation apparatus that includes a memory and processing circuitry, comprising:
a storage step in which the memory stores a resonance frequency f₁ of space formed by a user's ear and an open-ear type earphone; and
an estimation step in which the processing circuitry obtains a resonance frequency f₂ of the space formed by the user's ear and the open-ear type earphone by using a sound collection signal obtained by collecting sound by a microphone included in the open-ear type earphone when a predetermined signal is reproduced by a speaker included in the open-ear type earphone in a state where the user is wearing the open-ear type earphone, and estimates that the open-ear type earphone is worn at an ideal position of the user's ear when the resonance frequencies f₁ and f₂ coincide with each other, wherein
the resonance frequency f₁ is obtained by using the sound collection signal obtained by collecting sound by the microphone when the predetermined signal is reproduced by the speaker in the state where the open-ear type earphone is worn at the ideal position of the user's ear.

3. A non-transitory computer-readable recording medium having recorded thereon a program for causing a computer to function as the position estimation apparatus according to claim 1.
